(19) United States
(12) Patent Application Publication
(10) Pub. No.: US 2012/0290381 A1
(43) Pub. Date: Nov. 15, 2012

(54) Electronic payment system with variable transaction fee and variable rebate capabilities

(75) Inventors: Christopher Curtis Martin, Portsmouth, NH (US); Lynne Stewart Herrman, Scarborough, ME (US); Joseph Michael Hyland, III, Portsmouth, NH (US); Amy Beth Hoke, Gilford, NH (US)

(73) Assignee: Bottomline Technologies (DE) Inc., Portsmouth, NH (US)

(21) Appl. No.: 13/068,558

(22) Filed: May 13, 2011

(51) Int. Cl. G06Q 30/00

(52) U.S. Cl. 705/14.34

(57) ABSTRACT

A system for making payments from each payer of a community of payers to each supplier of a community of suppliers assesses a variable transaction fee to each supplier. The system comprises a database which associates, for each payer, identification of a group of transaction rates to apply to payments made by the payer. Associated with each transaction rate is a subgroup of suppliers to which the transaction rate applies on payments made by the payer. In response to receiving a payment instruction, a payment application generates a credit transaction to the account of the supplier in the amount of the payment less a transaction fee. The transaction fee is the amount of the first payment multiplied by the transaction rate, of the group of transaction rates associated with the payer, that associates with the subgroup of suppliers to which the first supplier is associated.

### TECHNICAL FIELD

The present invention relates to electronic payment and remittance systems, and more particularly, to an electronic payment and remittance system which assesses a variable transaction fee to each supplier and provides a variable rebate to each payer.

### BACKGROUND OF THE INVENTION

Electronic payments are becoming more common place for settling both consumer and business to business transactions.

The most common electronic payment mechanism in the consumer world is a payment card such as a credit card, charge card, or debit card. Generally, payment cards are issued by an operator of a card payment system such as American Express or Diners Club (sometimes called a closed loop system), or by a bank or financial institution under licensing from a bank card brand provider such as Visa or Mastercard (formerly bank card associations).

In a card payment system, the financial institution issuing the card handles authorizations and all aspects of the transaction and settles payment with the merchant/supplier and the consumer/cardholder. More specifically, when a consumer pays for a purchase using a credit card issued as part of a card payment system, the merchant/supplier's point of sale terminal is used to obtain, from the issuer, an authorization for the payment amount. The authorization represents a guarantee that the issuer will pay the authorized amount. Once authorization is obtained the merchant/supplier can provide the goods or services without concern as to whether the consumer will pay for the goods or services because consumer credit risk is on the issuer that provided the authorization (guarantee of payment), not the merchant/supplier that obtained the authorization (guarantee of payment). To settle the transaction, the issuer pays the merchant/supplier the authorized amount less a transaction fee. The transaction fee is established by contract between the merchant/supplier and the card payment system operator/issuer at the time the merchant/supplier opens its merchant account with the close loop system operator/issuer.

When a bank or financial institution issues a payment card under licensing from a bank card brand provider such as Visa or Mastercard, the bank is referred to as the Issuing Bank. To accept payment by payment card issued under license from a bank card brand provider, a merchant/supplier opens a merchant account with a bank of financial institution that is also licensed by the bank card brand provider. Bank at which the merchant/supplier has its merchant account is called the Acquiring Bank. The Issuing Bank and the Acquiring Bank may be different banks.

When a consumer pays for a purchase using a payment card licensed under a bank card brand provider, the supplier's point of sale terminal is used to access the brand provider's settlement network and obtain an authorization for the payment amount. The authorization represents a guarantee that the Issuing Bank will fund the authorized amount. Once authorization is obtained, the transaction is processed. More specifically, the Acquiring Bank funds the supplier's Merchant Account with the amount of the transaction less a transaction fee that is established by contract between the Acquiring Bank and the merchant/supplier. The Acquiring Bank obtains payment from the Issuing Bank through the brand provider's settlement network and pays a fee, called an interchange fee, to the brand provider. The brand provider keeps a portion of the interchange fee and credits a portion of the interchange fee back to the Issuing Bank.

The issuer in the card payment model and the Issuing Bank in the bank brand provider model may use a portion of the transaction fee (or the Issuing Bank's portion of the interchange fee) to fund a reward program that provides some financial benefit to the cardholder or, in the case of a commercial card program, rewards back to the company. Examples of reward programs include airline mileage reward programs and cash back rebate programs (for example 1% cash back). The terms and conditions of the reward program, and the financial benefit provided to the cardholder under the reward program, is controlled by the issuer/Issuing Bank.

Further, the issuer in the card payment model and the Issuing Bank in the bank brand provider model may charge the cardholder for use of the card. Such a charge is typically in the form of an annual fee. The amount of any charge to the cardholder is determined by the issuer/Issuing Bank.

It should be appreciated that the cardholder (i.e. the payer) making payment to the merchant/supplier does not determine the transaction fee paid by the supplier. The transaction fee paid by the supplier is determined by the issuer in the card payment model and the Acquiring Bank in the brand provider model.

Further, in the brand provider model: i) neither the cardholder (i.e. the payer) making payment to the merchant/supplier nor the Issuing Bank which issues the card to the cardholder determines the transaction fee paid by the supplier; and ii) neither the merchant/supplier nor the Acquiring Bank determines the fees paid by the cardholder for use of the account or the reward program or other benefit the cardholder receives for using the account.

There exist some limited exceptions where the merchant/supplier may have some control over the reward program or other benefit a cardholder receives for use of the issued card. These exceptions occur when the merchant/supplier has a direct relationship with the issuing bank such as: i) in the card payment model; and ii) in the brand provider model where the same financial institution is both the Acquiring Bank and the Issuing Bank. When such a direct relationship exists, the merchant/supplier and the issuing bank may be contract agree to a reward program for a co-branded card.

For example, an airline as a supplier/merchant may, by contract, with an issuer/Issuing Bank agree for the bank to issue co-branded payment cards. If done under the brand provider model, the Issuing Bank is also the Acquiring Bank for the airline.

The airline and the bank cannot control the interchange fee owed to the brand provider, but as part of the co-branding agreement the airline and the bank together can control: i) whether the airline pays a transaction fee for use of its merchant account at the Acquiring Bank; ii) whether the bank or the airline funds the interchange fee to the brand provider; iii) what charges (such as annual fee) are charged to the cardholder; iv) a portion, if any, of the annual fee or other charges the airline receives and a portion, if any, of the annual fee or other charges the bank receives; and v) the terms and conditions of the reward program and how the reward program is funded between the bank and the airline. The terms and conditions of the reward program and how the reward program is funded typically distinguish between use of the card to pay the airline and use of the card to pay third party suppliers which may have their merchant account's with other banks. When the card is used to pay the airline, the reward program may include additional points per dollar of eligible spend funded by the airline.

It must be appreciated that even with this exception it is the merchant/supplier and the issuer/Issuing Bank which together negotiate and determine the fees/charges assessed to the merchant/supplier and the nature of the reward program offered to the cardholder/payer.

In the consumer world, card payment has grown dramatically since the first card payment systems were introduced in the late 1940s and 1950s (Diners Club in 1949, American Express in 1959) and the first association branded cards were introduced in 1966 (BankAmericard which is now VISA, a card brand provider, and InterBank Card which is now MasterCard, a card brand provider). One of the primary drivers of growth has been that merchant/suppliers are willing to accept card payments and pay the corresponding transaction fee to eliminate credit risk of the individual consumer purchasing from the merchant/supplier. Once a transaction is authorized, payment to the merchant/supplier is guaranteed.

Recently, card issuers, in particular the bank card brand providers and their participating banks have been marketing card payments for business to business transactions. In general, an Issuing Bank issues a purchase card to a business and the business uses the card to pay suppliers. Suppliers must have a Merchant Account with an Acquiring bank and pay the applicable fees as determined by the Acquiring Bank. The Acquiring bank pays an interchange fee on the transaction, at least part of which is paid to the Issuing Bank. Currently purchasing card payments represent less than 4% of the business to business payments in the United States. It is speculated that purchasing card payments are not being adopted for business to business transactions as rapidly as adoption for consumer transactions for at least two reasons. First, most business to business payments are payments in the ordinary course of an ongoing relationship between the supplier and the payer and the supplier sees little credit risk in being paid. As such, the supplier sees little advantage of receiving a guarantee of payment at authorization, and while many suppliers may be willing to pay a small transaction fee for the convenience of immediate payments, the guarantee of immediate payment is not enough to justify payment of the high fixed transaction fee charged by the Acquiring Bank. Second, purchase card payments are difficult for both the payer and the supplier to reconcile in their respective accounts payable and accounts receivable accounting systems without at least duplicating manual entry of at least some payment/remittance information in multiple systems:

Even though there has been little adoption of purchase cards and card payments for business to business transactions, business to business payers still seek electronic payment solutions to lower costs associated with traditional check payments, and possible generate revenue from, their accounts payable.

In view of the foregoing, what is needed is an improved an electronic payment and remittance system when enables a payer to determine, on a vendor specific basis, the fee, if any, that the vendor will pay for receipt of payments and the rebate, if any, the payer will receive based on payments to each vendor.

### SUMMARY OF THE INVENTION

A first aspect of the present invention comprises a system for making payments from each payer of a community of payers to each supplier of a community of suppliers assesses a variable transaction fee to each supplier. The system comprises a database which associates, for each payer, identification of a group of transaction rates to apply to payments made by the payer. Associated with each transaction rate is a subgroup of suppliers to which the transaction rate applies on payments made by the payer. In response to receiving a payment instruction, a payment application generates a credit transaction to the account of the supplier in the amount of the payment less a transaction fee. The transaction fee is the amount of the first payment multiplied by the transaction rate, of the group of transaction rates associated with the payer, that associates with the subgroup of suppliers to which the first supplier is associated.

For a better understanding of the present invention, together with other and further aspects thereof, reference is made to the following description, taken in conjunction with the accompanying drawings. The scope of the invention is set forth in the appended claims.

### BRIEF DESCRIPTION OF THE DRAWINGS

FIG. 1 is a block diagram representing architecture of a system for making payments from each payer of a community of payers to each supplier of a community of suppliers assesses a variable transaction fee to each supplier, all in accordance with an exemplary embodiment of the present invention;

FIG. 2 is a block diagram representing a payer in accordance with an exemplary embodiment of the present invention;

FIG. 3 is a block diagram representing a payer in accordance with an exemplary embodiment of the present invention;

FIG. 4 is a table diagram representing data elements stored in, and relationships between data elements stored in, a supplier registry in accordance with an exemplary embodiment of the present invention;

FIG. 5 is a table diagram representing data elements stored in, and relationships between data elements stored in, a transaction rates table in accordance with an exemplary embodiment of the present invention;

FIG. 6a is a table diagram representing data elements stored in, and relationships between data elements stored in, a payer registry in accordance with an exemplary embodiment of the present invention;

FIG. 6b is a table diagram representing data elements stored in, and relationships between data elements stored in, a payer registry in accordance with an exemplary embodiment of the present invention;

FIG. 7a is a table diagram representing data elements stored in, and relationships between data elements stored in, a payment file in accordance with an exemplary embodiment of the present invention;

FIG. 7b is a table diagram representing data elements stored in, and relationships between data elements stored in, a payment file in accordance with an exemplary embodiment of the present invention;

FIG. 7c is a table diagram representing data elements stored in, and relationships between data elements stored in, a payment file in accordance with an exemplary embodiment of the present invention;

FIG. 8a is a ladder diagram representing a combination of data structures and instructions stored in memory and executed by a processor for making payments from each payer of a community of payers to each supplier of a community of suppliers assesses a variable transaction fee to each supplier, all in accordance with an exemplary embodiment of the present invention;

FIG. 8b is a ladder diagram representing a combination of data structures and instructions stored in memory and executed by a processor for making payments from each payer of a community of payers to each supplier of a community of suppliers assesses a variable transaction fee to each supplier, all in accordance with an exemplary embodiment of the present invention;

FIG. 8c is a ladder diagram representing a combination of data structures and instructions stored in memory and executed by a processor for making payments from each payer of a community of payers to each supplier of a community of suppliers assesses a variable transaction fee to each supplier, all in accordance with an exemplary embodiment of the present invention;

FIG. 8d is a ladder diagram representing a combination of data structures and instructions stored in memory and executed by a processor for making payments from each payer of a community of payers to each supplier of a community of suppliers assesses a variable transaction fee to each supplier, all in accordance with an exemplary embodiment of the present invention;

FIG. 8e is a ladder diagram representing a combination of data structures and instructions stored in memory and executed by a processor for making payments from each payer of a community of payers to each supplier of a community of suppliers assesses a variable transaction fee to each supplier, all in accordance with an exemplary embodiment of the present invention;

FIG. 9a is a flow chart representing exemplary instructions stored in memory and executed by a processor for determining a transaction fee to assess on a payment in accordance with an exemplary embodiment of the present invention; and

FIG. 9b is a flow chart representing exemplary instructions stored in memory and executed by a processor for determining a transaction fee to assess on a payment in accordance with an exemplary embodiment of the present invention.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code/instructions which is encoded within computer readable media accessible to the processor, or a combination of a hardware circuit(s) and a processor or control block of an integrated circuit executing machine readable code encoded within a computer readable media. As such, the term circuit, module, server, application, or other equivalent description of an element as used throughout this specification is intended to encompass a hardware circuit (whether discrete elements or an integrated circuit block), a processor or control block executing code encoded in a computer readable media, or a combination of a hardware circuit(s) and a processor and/or control block executing such code.

It should also be appreciated that table structures represented in this application are exemplary data structures only and intended to show the mapping of relationships between various data elements. Other table structures may store similar data elements in a manner that maintains the relationships useful for the practice of the present invention.

Within this application the applicant has depicted and described groups of certain elements. As used in this application, the term group means at least three of the elements. For example, a group of suppliers means at least three suppliers. When a group, for example a first group, is referred to as being distinct, or distinct from a second group, it means that the first group contains at least one element that is not present in the second group and the second group includes at least one element that is not present in the first group. The use of the term unique with respect to an element within a group or set of elements means that that the element is different then each other element in the set or group.

Within this application, the applicant has used the term database to describe a data structure which embodies groups of records or data elements stored in a volatile or non volatile storage medium and accessed by an application, which may be instructions coded to a storage medium and executed by a processor. The application may store and access the database.

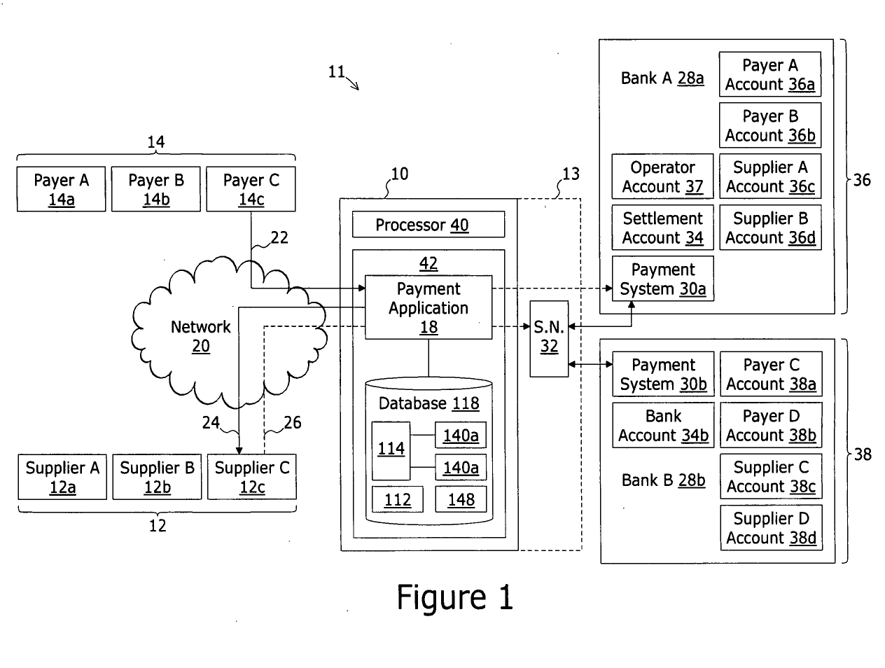

Turning to FIG. 1, an exemplary architecture 11 is shown in which a payment bureau 10 executes payments from each payer 14a, 14b, 14c of a community of payers 14 to each supplier 12a, 12b, 12c of a community of suppliers 12, assessing a variable transaction fee to each supplier in conjunction with executing a payment from a payer to the supplier, and providing a variable rebate to the payer.

The system 10 is communicatively coupled to each payer 14a, 14b, 14c of the community of payers 14 and to each supplier 12a, 12b, 12c of the community of suppliers 12 via an open network 20 such as the public internet.

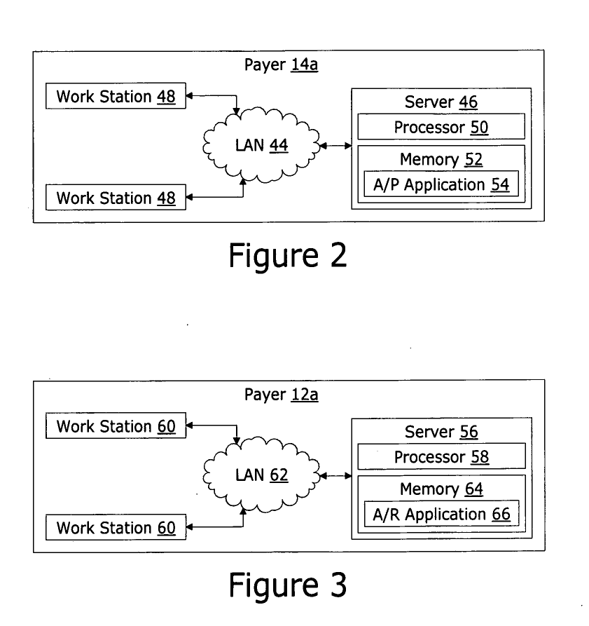

Turning briefly to FIG. 2 in conjunction with FIG. 1, in an exemplary embodiment, each payer, using payer 14a for example, may be a business that includes at least one computer system or server 46. The computer system(s) or server(s) 46 include at least one processor 50 and associated memory 52 programmed with an accounts payable application 54.

In a typical environment, the computer system(s) or server(s) 46 operating the accounts payable application 54 may be coupled to a local area network 44 and accessed by entitled users of workstations 48 and may be used for managing the payer's accounts payables and issue payments to its vendors.

Turning briefly to FIG. 3 in conjunction with FIG. 1, in an exemplary embodiment, each supplier, using supplier 12a for example, may be a business that includes at least one computer system or server 56. The computer system(s) or server(s) 56 include at least one processor 58 and associated memory 64 programmed with an accounts receivable application 66.

In a typical environment, the computer system(s) or server(s) 56 operating the accounts receivable application 66 may be coupled to a local area network 62 and accessed by entitled users of workstations 60 and may be used for managing the supplier's accounts receivables and reconciling payments issued by customers (i.e. payers) against amounts due to the supplier.

Returning to FIG. 1, for purposes of illustrating the invention, at least two banks 28a and 28b are represented. Each bank, for example bank 28a, may include a payment system 30a (i.e. instructions coded to a computer readable medium and executed by a processor) which manages deposit accounts 36, including execution of credit and debit transactions to deposit accounts 36 in a traditional manner. Similarly bank 28b may include a payment system 30b (i.e. instructions coded to a computer readable medium and executed by a processor) which manages deposit accounts 36, including execution of credit and debit transactions to deposit accounts 36 in a traditional manner.

The payment system 30a, 30b of each bank 28a, 28b may further be coupled to a settlement network 32 which transfers funds between banks for settlement payments between accounts a different banks. Exemplary settlement networks include the National Automated Clearing House Association (NACHA) for settling ACH transactions and Federal Reserve for settling wire transactions. The settlement network may also be a bank card association, such as associations known as Visa or MasterCard, which settles payments typically referred to as card payments.

Each bank may include, and each banks payment system 30a, 30b may also manage, multiple customer accounts 36 (for bank 28a) and 38 (for bank 28b). Each customer account is an account to which credit and debit transactions are posted representing credits and debits to the funds of a particular customer associated with the account (i.e. the account holder).

For example, bank 28a may have a customer account 36a for Payer 14a, a customer account 36b for payer 14b, a customer account 36c for supplier 12a, a customer account 36d for supplier 12b.

For example, bank 28b may have a customer account 38a for Payer 14c, a customer account 38b for payer 14d, a customer account 38c for supplier 12c, a customer account 38d for supplier 12d.

Each customer account for a payer may be a deposit account such as a commercial checking account. Each customer account for a supplier may be a deposit account such as a commercial checking account or a merchant services account such as an account funded upon settlement of a card payment transaction.

For purposes of illustrating this invention, bank 28a may further include, and the banks' payment system 30a may further manage, an operator account 37 which may be a deposit account, such as a commercial checking account, to which credits and debit transactions are posted representing credits and debits to funds of the operator of the system 10.

For purposes of illustrating this invention, bank 28a may further include, and the banks' payment system 30a may further manage, a settlement account 34 which may be a fiduciary consolidation account, such as a commercial checking account, to which credits and debit transactions are posted representing credits to fund payments to be issued by payers and debits to disburse payment to suppliers.

In an exemplary embodiment, the payment bureau 10 may be communicatively coupled to at least one payment system of at least one bank, for example payment system 30a of bank 28a. This may be the payment system 30a which manages the operator account 37 and the settlement account(s) 34.

In another exemplary embodiment, the system 10 may further be coupled to the settlement network 32, or may alternatively be coupled to the settlement network 32 in lieu of being coupled to a payment system 30a of a bank 28a.

In yet another exemplary embodiment, the settlement network may be part of the payment bureau 10 as depicted by the dashed line 13 in FIG. 1. For example, if the payment bureau 10 is operated by a bank card association the payment bureau 10 may include a proprietary settlement network 32.

The payment bureau 10 may be a computer system of one or more servers comprising at least a processor 40 and computer readable medium 42. The computer readable media may include encoded thereon a payment application 18 and database 118. The payment application 18 may be a computer program comprising instructions embodied on computer readable medium 42 and executed by the processor 40. The database 118 may include data structures, also referred to as tables, as described herein.

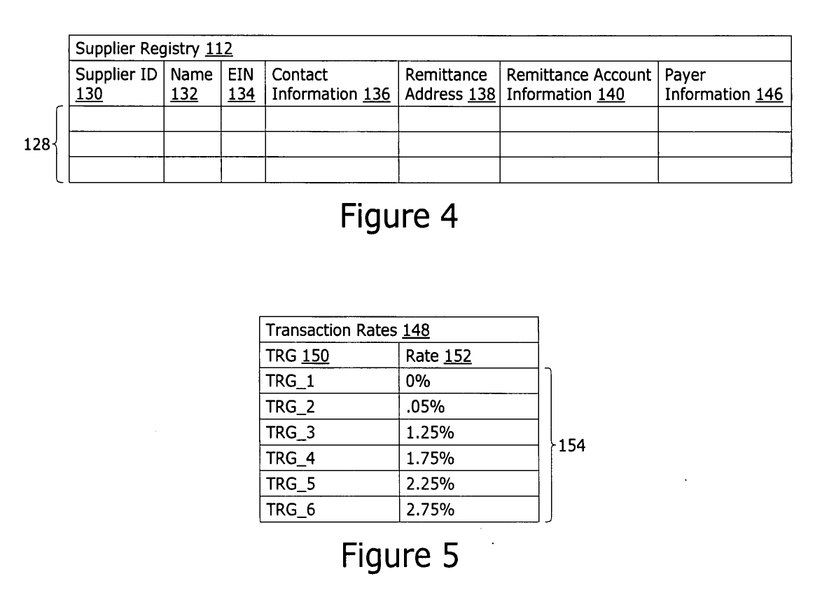

Turning briefly to FIG. 4 in conjunction with FIG. 1, the database 118 may include, as one of the data structures, a supplier registry 112. The supplier registry 112 may comprise a group of supplier records 128. The group of supplier records 128 may comprise unique records, each of which is associated with, and identifies, a unique one of the suppliers of the community of suppliers 12 by inclusion of a unique supplier ID within a supplier ID field 130 of the record.

Also associated with the supplier may be: i) the suppliers name included in a name field 132; ii) the supplier's tax identification number included in a tax ID field 134; iii) the supplier's contact information included in a contact information field 136; iv) the suppliers remittance address included in a remittance address field 138; and v) the suppliers remittance account information included in a remittance account information field 140.

The vendor's name 132 may be the official name of the entity as recorded in official records of the jurisdiction in which it is formed and as used for titling its bank accounts, including its remittance account.

The vendor's remittance address 138 may be an address the vendor typically uses for receiving checks from its customers by regular mail (for example a lock box address).

The vendor's contact information 136 may include the name of an individual in the vendor's accounts receivable department responsibility for managing the vendor's accounts receivable matters with the payers 22.

The vendor's remittance account information 140 may include bank account information (such as routing number and account number) and/or other information needed by the payment bureau to execute deposits to the vendor in accordance with payment authorization instructions provided by a payer.

Turning to FIG. 5, the database 118 may include, as one of the data structures, a transaction rates table 148. The transaction rates table 148 associates a transaction rate, which may be a percentage of a transaction value, with a transaction rate group identifier. More specifically, the transaction rate table 148 may include a group of records 154. Each record may associate a unique transaction rate group identifier (within a transaction rate group field 150) with a unique transaction rate (within a transaction rate field 152).

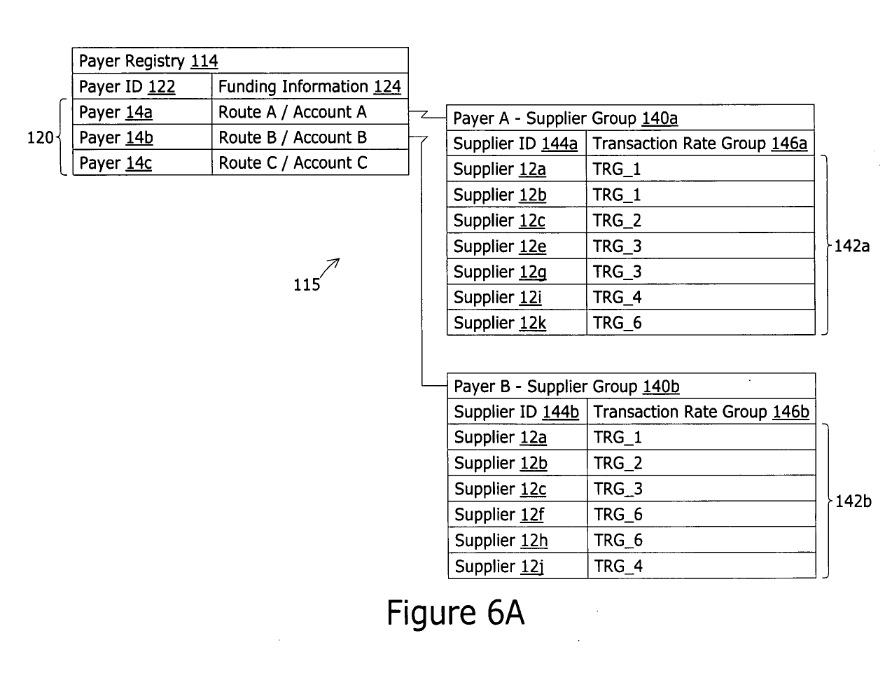

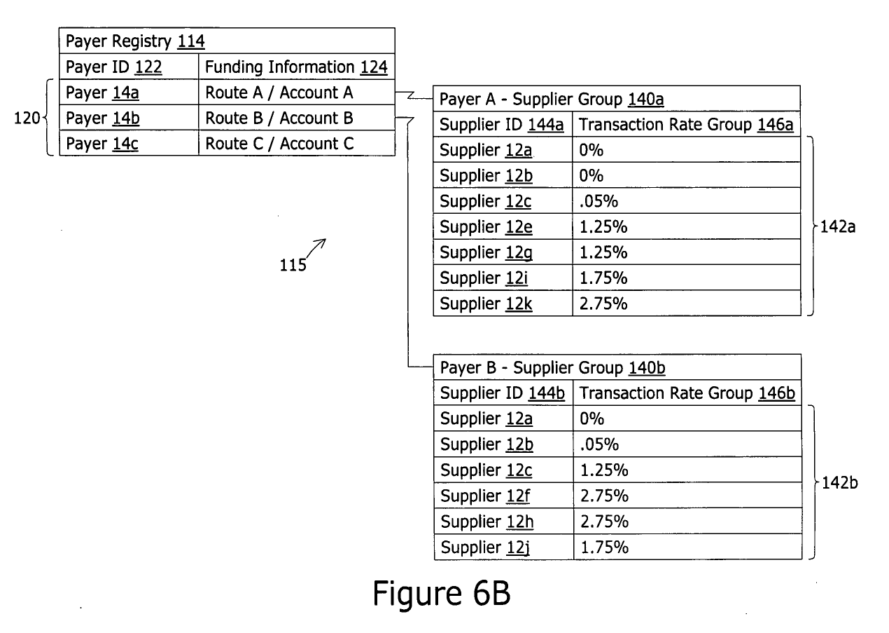

Turning to FIG. 6s in conjunction with FIG. 1, the database 118 may include, as one of the data structures, a data structure 115 which includes, for each payer 14a, 14b, 14c within the community of payers 14, identification of the payer and, in association with identification of the payer, identification of the payer's unique payer supplier subgroup. The payer's unique payer supplier subgroup is the group of suppliers to which the payer makes payment using the payment bureau 10. The payer's payer supplier subgroup may be a subset of the community of suppliers 12 that consists of fewer than the entire community of suppliers and is distinct from each of the other payer's unique payer supplier subgroup.

More specifically, the data structure 115 may include a payer registry 114. The payer registry 114, may comprise a group of payer records 120. Each record 120 is associated with, and identifies a unique one of the payers 14a, 14b, 14c of the community of payers 14 by inclusion of a unique payer ID within a payer ID field 122 of the record.

Also associated with each payer is funding information unique to the payer and stored in at least one funding information field 124 of the record. The funding information may include bank account information (which may be a routing number and account number) identifying a bank deposit account belonging to the payer and/or other information used by the payment bureau 10 to execute payments from the account belonging to the payer to an account associated with a supplier within the payer's supplier subgroup in accordance with payment authorization instructions provided by the payer.

Each record of the payer registry 114 may be associated with a unique payer supplier group table, for example the record for payer 14a (with payer ID “Payer A”) may be associated with payer supplier group table 140a and the record for payer 14b (with payer ID “Payer B” may be associated with payer supplier group table 140b.

Payer supplier group table 140a, associated with payer 14a, may include identification of payer 14a, and a supplier ID for each supplier in Payer 14a's unique payer supplier subgroup. More specifically, the payer supplier group table 140a may include a group of records 142a with each record being unique to one of the supplier's within payer 14a's payer supplier subgroup.

Each record 142a may include a supplier ID within a supplier ID field 144a which identifies the supplier and associates the record with the supplier. For example, payer 14a's payer supplier subgroup may consists of seven (7) suppliers, supplier 12a, supplier 12b, supplier 12c, supplier 12e, supplier 12g, supplier 12i, and supplier 12k, which is fewer then all suppliers within the community of suppliers 12. Within the supplier group table 140a, each of such supplier's is associated with a unique record that includes the Supplier ID within the supplier ID field 114a.

The payer suppler group table 140a also associates each suppler with a transaction rate that applies to payments from Payer 14a to the supplier. More specifically, a transaction rate group identifier (corresponding to one of the transaction rate group identifiers from a record of the transaction rates table 148 of FIG. 5) may be within a transaction rate group field 146a of the record 142a associated with the supplier.

For example, identification of first transaction rate (TRG_1) is associated with identification of Supplier 12a indicating that a first transaction rate applies to payments from Payer 14a to Supplier 12a. Similarly, the first transaction rate (TRG_1) is also associated with identification of Supplier 12b, a second transaction rate (TRG_2) is associated with identification of Supplier 12c, a third transaction rate (TRG_3) is associated with identification of Supplier 12e, the third transaction rate (TRG_3) is also associated with identification of Supplier 12g, a fourth transaction rate (TRG_4) is associated with identification of Supplier 12i, and a fifth transaction rate (TRG_6) is associated with identification of supplier 12k.

For example, payer 14b's payer supplier subgroup may consists of six (6) suppliers, supplier 12a, supplier 12b, supplier 12c, supplier 12f, supplier 12h, and supplier 12j, which is fewer then all suppliers within the community of suppliers 12. Within the supplier group table 140b, each of such suppliers is associated with a unique record that includes the Supplier ID within the supplier ID field 114b.

The payer suppler group table 140b also associates each suppler with a transaction rate that applies to payments from Payer 14b to the supplier. More specifically, a transaction rate group identifier (corresponding to one of the transaction rate group identifiers from a record of the transaction rates table 148 of FIG. 5) may be within a transaction rate group field 146b of the record 142b associated with the supplier.

For example, identification of first transaction rate (TRG_1) is associated with identification of Supplier 12a indicating that a first transaction rate applies to payments from Payer 14b to Supplier 12a, a second transaction rate (TRG_2) is associated with identification of Supplier 12b, a third transaction rate (TRG_3) is associated with identification of Supplier 12c, the fourth transaction rate (TRG_6) is associated with identification of Supplier 12f and Supplier 12h, and a fifth transaction rate group (TRG_4) is associated with identification of supplier 12j.

It should be appreciated that the group of transaction rates associated with each payer's payer supplier subgroup may be only a subgroup of the group of rates represented within the transact rates table 148 (FIG. 5), such subgroup being fewer than the entire group of rates represented within transaction rates table 148, and may be distinct from the group of transaction rates associated with each of the other payer's payer supplier subgroup.

In the example represented by FIG. 6a, transaction rate group (TRG_5) is not used as a transaction rate group for the supplier's within Payer 14a's payer supplier subgroup. As will be discussed, this will be common in an example wherein each payer may select only five (5) transaction rates from a group of transaction rates consisting of greater than five transaction rates.

It should also be appreciated that the data structure represented by FIG. 6 effectively identifies each supplier within a subgroup of the payer supplier subgroup, to which each transaction rate applies. For example, within payer 14a's payer supplier subgroup, a first transaction rate (TRG_1) applies to a first subgroup of suppliers consisting of supplier 12a and supplier 12b; a second transaction rate (TRG_2) applies to a second subgroup of suppliers consisting of only supplier 12c; a third transaction rate (TRG_3) applies to a third subgroup of suppliers consisting of supplier 12e and supplier 12g; a fourth transaction rate (TRG_4) applies to a fourth subgroup of suppliers consisting of only supplier 12i; and a fifth transaction rate (TRG_6) applies to a firth subgroup of suppliers consisting of only supplier 12k.

Similarly, within payer 14b's payer supplier subgroup, a first transaction rate (TRG_1) applies to a first subgroup of suppliers consisting of only supplier 12a; a second transaction rate (TRG_2) applies to a second subgroup of suppliers consisting of only supplier 12b; a third transaction rate (TRG_3) applies to a third subgroup of suppliers consisting of only supplier 12c; a fourth transaction rate (TRG_6) applies to a fourth subgroup of suppliers consisting of supplier 12f and supplier 12h; and a fifth transaction rate (TRG_5) applies to a firth subgroup of suppliers consisting of only supplier 12j.

It should be appreciated that, within each payer's payer supplier subgroup, each supplier in each subgroup is different from each suppler in each other subgroup. Stated another way, no supplier is within multiple subgroups of any payer's payer supplier subgroup.

FIG. 6b represents an alternative data structure, which is essentially the same data structure as depicted and discussed with respect to FIG. 6a, which the material difference being that a value representative of a transaction rate is stored in the transaction rate group field 146 of each record of each payer supplier subgroup table 140. The value representative of the transaction rate may be unrestricted or may be a value associated with a rate selected from a group of rates consisting of a limited quantity of unique rates that may be chosen. If unrestricted, the quantity of transaction rates could be infinite, restricted only by the quantity of significant digits used for storing the rate. If the value is selected from a group of rates, for example the group of rates consisting of the percentages from 0% to 3% increments of one-quarter percent, the total quantity of rates would be finite.

Turning to FIG. 1, in operation, the payment bureau 10 processes payments, each payment being initiated by one of the payer's within the community of payers 14, for payment of a payment amount from the payer's account to one of the suppliers within the community of suppliers 12. More specifically, from each payer 14a, 14b, 14c of the community of payers 14, the payment bureau 10 receives a payment instruction file identifying payments to process for the payer. For example, arrow 22 represents receipt of a payment instruction file from payer 14c identifying payments to process for payer 14c, the payments being payments to a group of supplier's within the payer 14a's payer supplier subgroup.

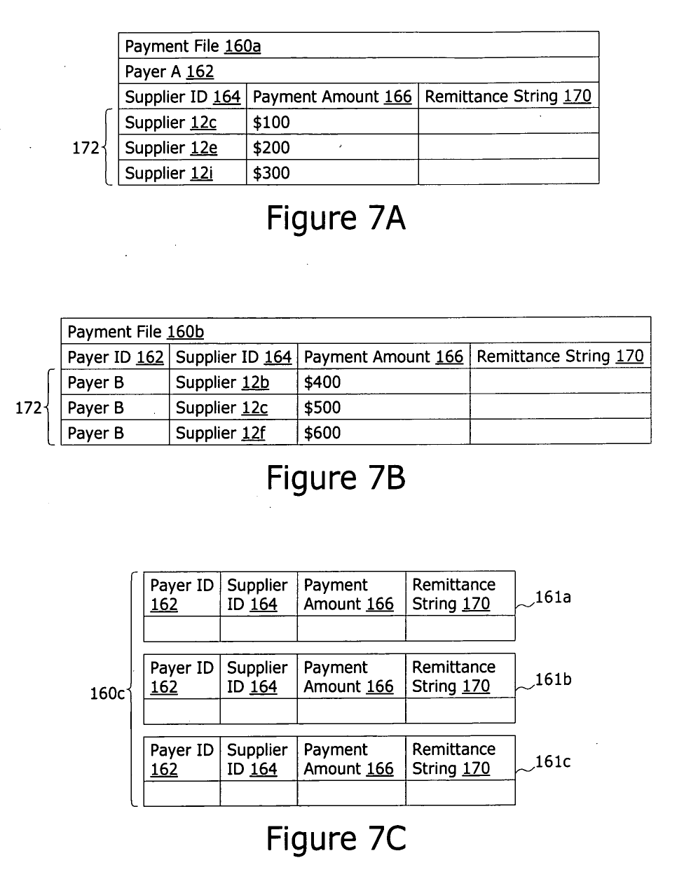

Referring to FIG. 7a a first exemplary payment instruction data structure, or payment instruction file is depicted. Referring to FIG. 1 in conjunction with FIG. 7a, the payment file 160a may comprises identification of the payer within a payer ID field 162 (Payer ID “Payer A” representing payer 14a) and, associated with that payer ID field 152, a group of unique records 172, each record representing a unique payment instruction. Each record 172 includes: i) identification of the supplier to which payment is to be made by inclusion of the supplier's Supplier ID (from the supplier registry 112) within a supplier ID field 164; ii) identification of the amount of the payment to be made to the supplier by inclusion of a payment amount within a payment amount field 166; and iii) remittance information, which may be alpha numeric information identifying what payable is being paid, within a remittance string field 170. The remittance information may identify the supplier's invoice being paid, goods or services for which payment is being made, or other aspects of an underlying transaction between the payer and supplier giving rise to the payment associated with the record.

FIG. 7b represents a second exemplary payment instruction data structure, or payment instruction file. Referring to FIG. 1 in conjunction with FIG. 7b, the payment file 160b may comprise a group of unique records 172, each record representing a unique payment instruction. Each record 172 includes: i) identification of the payer within a payer ID record 162 (i.e. Payer ID “Payer B” representing payer 14b)); ii) identification of the supplier to which payment is to be made by inclusion of the supplier's Supplier ID (from the supplier registry 112) within a supplier ID field 164; iii) identification of the amount of the payment to be made to the supplier by inclusion of a payment amount within a payment amount field 166; and iv) remittance information, which may be alpha numeric information identifying what payable is being paid, within a remittance string field 170. Again, the remittance information may identify the supplier's invoice being paid, goods or services for which payment is being made, or other aspects of an underlying transaction between the payer and supplier giving rise to the payment associated with the record.

FIG. 7c represents a third exemplary payment instruction data structure, or payment instruction file. Referring to FIG. 1 in conjunction with FIG. 7c, a group of independent payment instructions, comprising payment unique instructions 161a, 161b and 161c, may in the aggregate be a payment instruction file 160c.

Each payment instruction may include: i) identification of the payer within a payer ID record 162; ii) identification of the supplier to which payment is to be made by inclusion of the supplier's Supplier ID (from the supplier registry 112) within a supplier ID field 164; iii) identification of the amount of the payment to be made to the supplier by inclusion of a payment amount within a payment amount field 166; and iv) remittance information, which may be alpha numeric information identifying what payable is being paid, within a remittance string field 170. Again, the remittance information may identify the supplier's invoice being paid, goods or services for which payment is being made, or other aspects of an underlying transaction between the payer and supplier giving rise to the payment associated with the record.

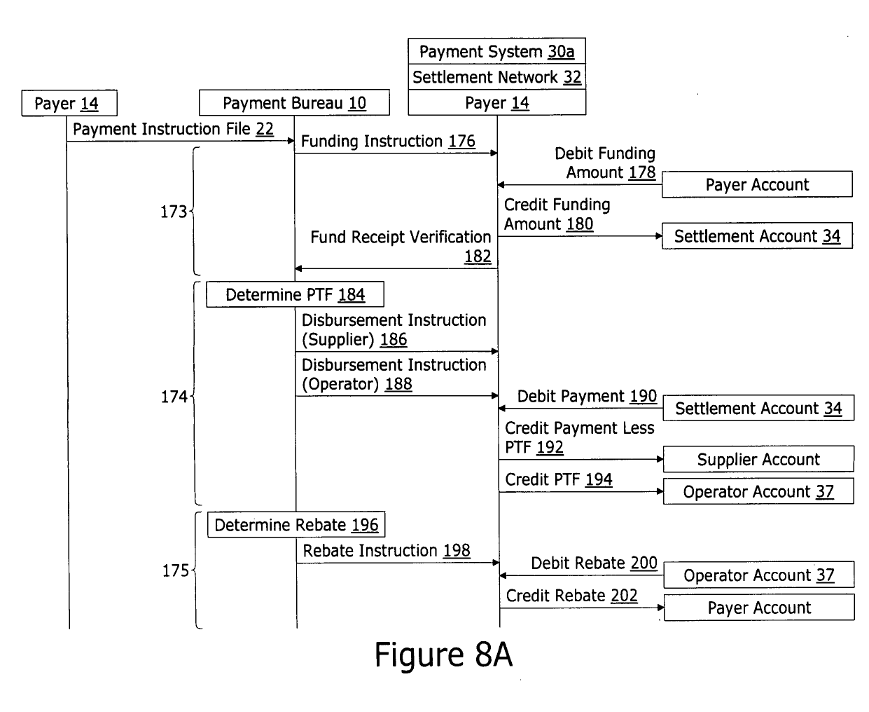

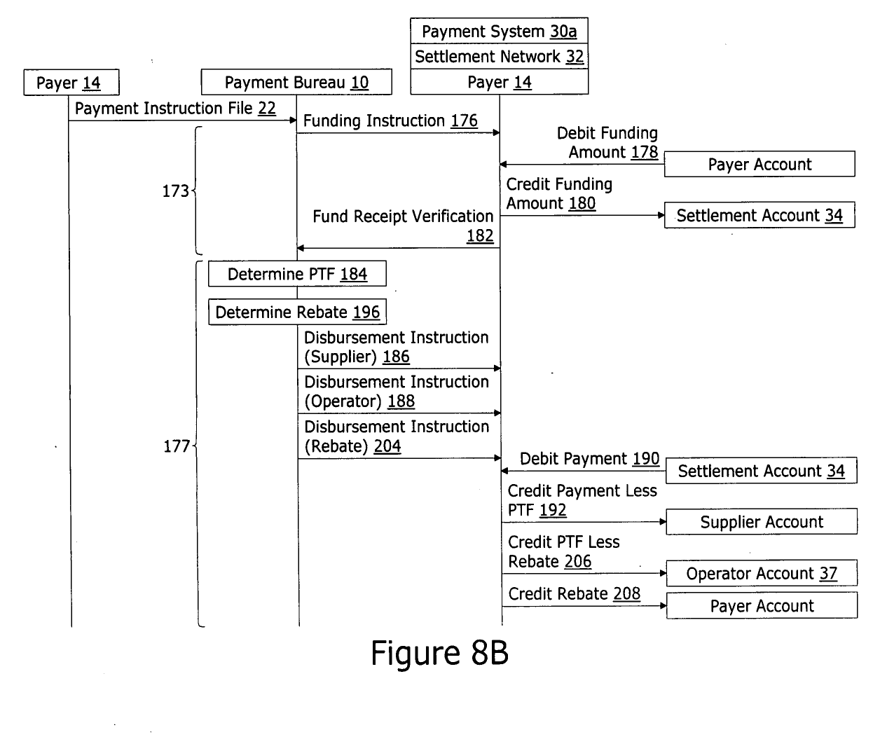

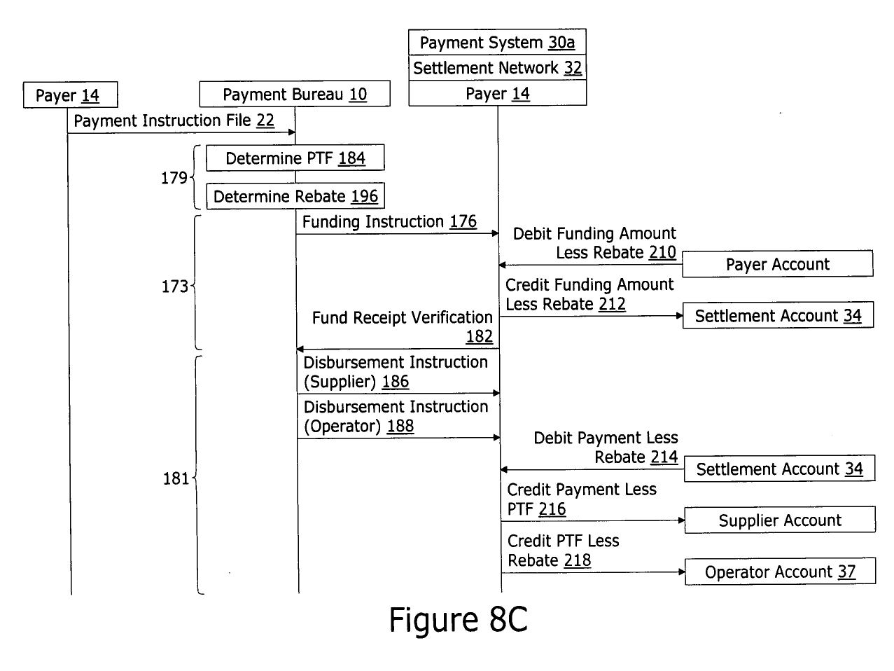

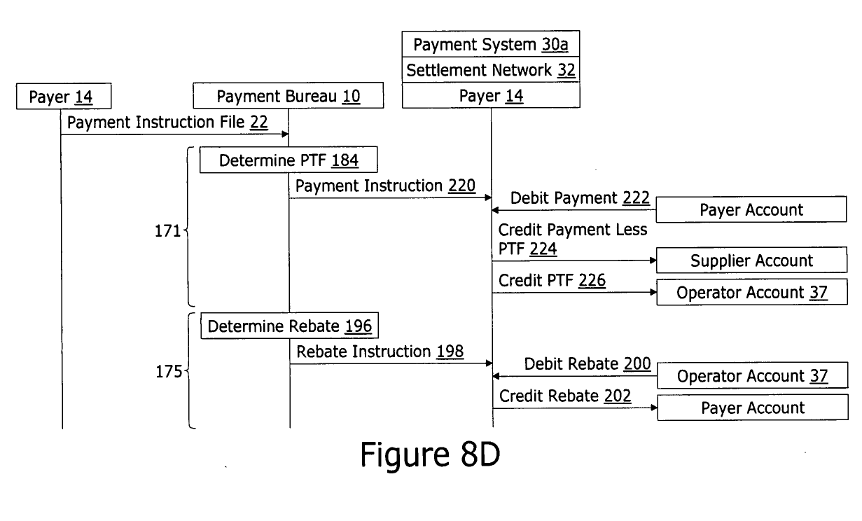

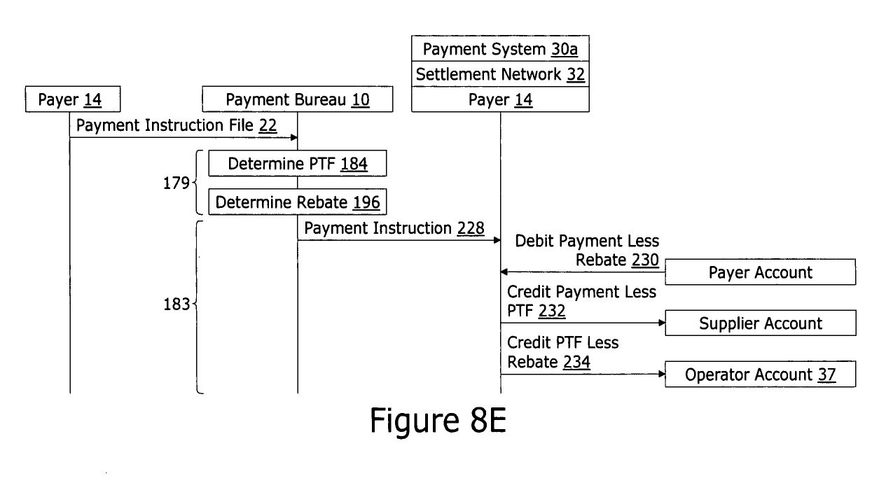

Referring to the ladder diagram of FIG. 8a in conjunction with FIG. 1, in an exemplary embodiment of operation, the payment bureau 10 receives a payment file, for example payment file 160a (FIG. 7a) from payer 14a, as represented by step 22. The payment instruction file may be transferred via a secure connection over the network 20 which may include implementing encryption of the connection and/or the file transferred over the connection.

Upon receiving and authenticating the payment file 160, the payment bureau 10, or more specifically, the processor 40 executing the payment application 18, performs funding steps 173 to transfer a funding amount equal to the aggregate or sum of the amount of all payments in the payment file 160 from the payer's account (account 36a at bank 28a) to the settlement account 34.

The funding steps 173 may include generating a funding instruction 176 to the payment system 30a to which the payment bureau 10 is coupled. The funding instruction 176 may include initiation of a debit transaction to debit the funding amount from the payer's transaction account (account 36a) as represented by step 178 and a credit transaction to credit to the settlement account 34 the funding amount as represented by step 180. The funding steps 173 may further include the payment system 30a providing a message back to the payment bureau verifying that the funding amount has been received in the settlement account 34.

The debit of the payer's account and credit to the settlement account may be by funds transfer if both accounts are held at the same bank, by transfer through a settlement network 32 (for example via ACH or Wire) if the payers account and settlement account are held at different banks.

In a second funding embodiment, the funding instruction 176 may be an instruction, or a debit/credit instruction pair, sent directly by the payment application 18 to the settlement network 32 to effect the initiation of a debit transaction to debit the funding amount from payer's account (account 36a) as represented by step 178 and initiation of a credit transaction to credit to the settlement account 34 the funding amount as represented by step 180.

As discussed, the settlement network 32 may be separate from the payment bureau 10, such as the Fedwire settlement network or the ACH settlement network, or may be a proprietary component of the payment bureau 10, such as a bank card association settlement network. In an embodiment wherein the settlement network 32 is part of the payment bureau 10, the settlement network 32 may be an application comprising instructions stored on the computer readable medium 42 and executed by processor 40, such instructions implementing the credit and debit transactions as described in this specification.

In a third funding embodiment, the funding instruction 176 may be a message to the payer from which the payment file was received. The payer may then, accessing a payment system 30 at the payer's bank or a settlement network, initiate a debit transaction to debit the funding amount from payers account (account 36a) as represented by step 178 and initiation of a credit transaction to credit to the settlement account 34 the funding amount as represented by step 180. The message to the payer may simple be a message acknowledging receipt of the payment file.

In both the second funding embodiment and the third funding, the verification of receipt of the funding amount in the settlement account 34 may be a message to the payment bureau 10 that is generated by the bank at which the settlement account 34 is held.

After the funding amount is received in the settlement account 34, disbursement steps 174 are performed for each payment represented in the payment file. In executing the disbursement steps 174 for a payment, the payment bureau 10 identifies a payment transaction fee to apply to the payment at step 184.

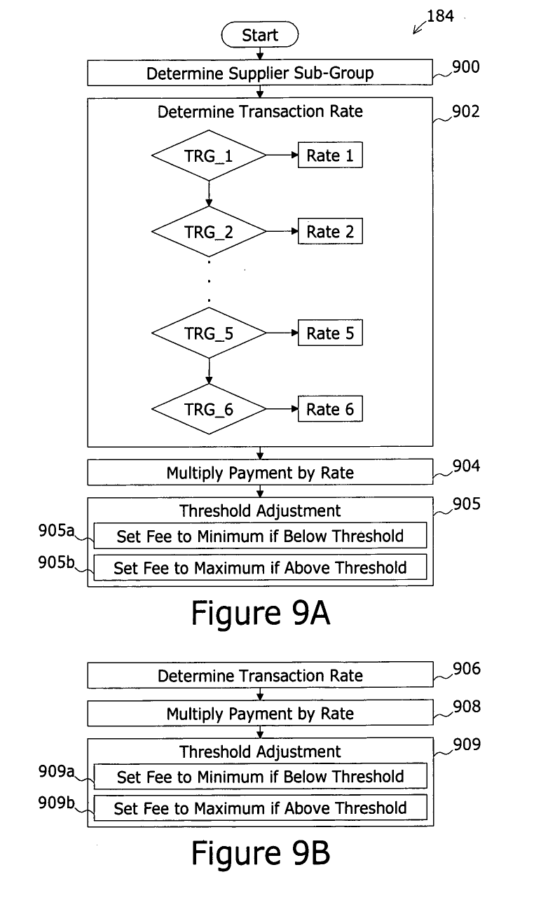

Turning briefly to flow chart of FIG. 9a, in conjunction with FIG. 6a, identifying the payment transaction fee to apply to a payment may comprise, as represented by step 900, looking up, in the database 118, the subgroup of the payer's payer supplier subgroup to which the supplier is a member.

For example, the first payment represented in payment file 160a, represents a payment of $100 from payer 14a to supplier 12c. In this example, the payment bureau 10, at step 900, looks up in the payer supplier group table 140a associated with payer 14a, the transaction rate group identified in the record associated with supplier 12c (i.e. TRG_2) to determine the transaction rate group in which the supplier belongs. This process effectively distinguishes whether the supplier 12c is a member of a first subgroup, second subgroup, third subgroup, fourth subgroup, or fifth subgroup of the payer 14a's payer supplier group.

Referring to FIG. 5 in conjunction with FIG. 9a, step 902 represents looking up, in the database 118, the transaction rate applicable to the subgroup in which the supplier 12c is a member. More specifically, the transaction rate may be a first rate (0%) if the supplier is a member of transaction rate group TRG_1; transaction rate may be a second rate (0.05%) if the supplier is a member of transaction rate group TRG_2; transaction rate may be a third rate (1.25%) if the supplier is a member of transaction rate group TRG_3; transaction rate may be a fourth rate (1.75%) if the supplier is a member of transaction rate group TRG_4; transaction rate may be a fifth rate (2.25%) if the supplier is a member of transaction rate group TRG_5; and transaction rate may be a sixth rate (2.75%) if the supplier is a member of transaction rate group TRG_6.

Returning again to FIG. 9a, step 904 represents determining the payment transaction fee by multiplying the amount of the payment (i.e. $100 in the example) by the applicable transaction rate (i.e. 0.05% in the example because supplier 12c is in transaction rate group TRG_2 for payments from payer 14a—as discussed with respect to FIG. 6a) to yield the payment transaction fee (i.e. $0.50 in the example).

Step 905 represents making a threshold adjustment to the transaction fee determined at step 904 in the event the transaction fee, as determined at step 904, is below a minimum threshold or above a maximum threshold.

Sub-step 905a represents setting the transaction fee to a predetermined minimum transaction fee in the event the transaction fee, as determined at step 904 is below a threshold equal to the minimum transaction fee. For example, if the predetermined minimum transaction fee is $0.75 and the transaction fee as determined at step 904 is $0.50, then, at step 905a the transaction fee would be reset to $0.75.

Sub-step 905b represents setting the transaction fee to a predetermined maximum transaction fee in the event the transaction fee, as determined at step 904 is above a threshold equal to the maximum transaction fee. For example, if the predetermined maximum transaction fee is $20.00 and the transaction fee as determined at step 904 is above $20.00, then, at step 905b the transaction fee would be reset to $20.00.

FIG. 9b represents alternative steps to determine the payment transaction fee to apply to a payment that is useful in operation with the data structure depicted by FIG. 6b. Referring to FIG. 9b in conjunction with FIG. 6b, step 906 represents looking up, in the database 118, in the payer supplier subgroup table associated with the payer (i.e. payer supplier subgroup table 142a associated with payer 14a for the example) the transaction rate identified in the record associated with the supplier (i.e. transaction rate of 0.5% from the record associated with supplier 12c for the example) to determine which transaction rate group the supplier belongs (i.e. to effectively determine that supplier 12c belongs to the 0.05% transaction rate group for the example).

As with the process of FIG. 9a, this process of FIG. 9b effectively distinguishes whether the supplier 12c is a member of a first subgroup (the 0.05% subgroup) or a member of a subgroup associated with a different rate.

Step 908 represents determining the payment transaction fee by multiplying the amount of the payment (i.e. $100 in the example) by the applicable transaction rate (i.e. 0.05% in the example because supplier 12c is in the 0.05% transaction rate group for payments from payer 14a to yield the payment transaction fee (i.e. $0.50 in the example).

Step 909 represents making a threshold adjustment to the transaction fee determined at step 908 in the event the transaction fee, as determined at step 908, is below a minimum threshold or above a maximum threshold.

Sub-step 909a represents setting the transaction fee to a predetermined minimum transaction fee in the event the transaction fee, as determined at step 908 is below a threshold equal to the minimum transaction fee. For example, if the predetermined minimum transaction fee is $0.75 and the transaction fee as determined at step 908 is $0.50, then, at step 909a the transaction fee would be reset to $0.75.

Sub-step 909b represents setting the transaction fee to a predetermined maximum transaction fee in the event the transaction fee, as determined at step 908 is above a threshold equal to the maximum transaction fee. For example, if the predetermined maximum transaction fee is $20.00 and the transaction fee as determined at step 908 is above $20.00, then, at step 909b the transaction fee would be reset to $20.00.

Returning to FIG. 8a, step 186 represents the payment bureau 10 generating disbursement instructions 186 and 188 to the payment system 30a to initiate: i) a debit transaction, or multiple debit transactions, to debit the payment amount from the settlement account 134 as depicted by step 190; ii) a credit transaction to credit the payment amount less the transaction fee to the supplier's transaction account as depicted by step 192; and iii) a credit transaction to credit the transaction fee to the operator account 37 as depicted by step 194.

The debit(s) of the settlement account and credits to the supplier's transaction account and operator account by funds transfer if between accounts held at the same bank or by transfer through a settlement network 32 if between accounts are held at different banks.

In an alternative embodiment, the disbursements instructions 186 and 188 may each be an instruction, or a debit/credit instruction pair, sent directly by the payment application 18 the settlement network 32 (whether separate from, or part of the payment bureau 10) to effect the initiation of a debit transaction to debit the applicable amount from the settlement account and credit the amount of the payment less the transaction fee to the supplier account and to credit the transaction fee to the operator account.

As discussed, the payment bureau will complete the disbursement steps 174 for each payment within the payment file 160a, which for the second payment represented in the payment file 160a (i.e. a payment of $200 to supplier 12e) includes identifying a payment transaction fee to apply to the second payment at step 184, using the process described with respect to FIG. 9a or FIG. 9b, and generating the disbursement instructions to effect the credits and debits as discussed with respect to steps 186 through 194.

Similarly for the third payment represented in the payment file 160a (i.e. a payment of $300 to supplier 12i) includes identifying a payment transaction fee to apply to the third payment at step 184, using the process described with respect to FIG. 9a or FIG. 9b, and generating the disbursement instructions to effect the credits and debits as discussed with respect to steps 186 through 194.

It should be appreciated that the disbursement instructions to effect the credits and debits as discussed with respect to steps 186 through 194, for each of multiple transactions, may be grouped in batches for transmission to the payment system 30a or the settlement network 32, more specifically, the instructions associated with each of the first payment, second payment, and third payments may be transmitted at the same time as part of a batch.

Although the foregoing description of the funding instructions 173 and disbursement instructions 174 contemplate funding the settlement account for the aggregate amount of all payments within the payment file through a single funding transaction. In an alternative, the funding instructions 173 may be independently performed for each payment within the payment file, in each case funding only the amount of the particular payment to the settlement account.

After disbursement instructions 174 are executed for each payment within the payment file 160, rebate instructions 175 may be executed for calculating and paying a rebate to the payer. More specifically, step 196 represents calculating a rebate due to the payer. The rebate amount due to the payer may be a fraction of the transaction fee applied to each payment made by the payer, the fraction being less than one. Or, stated another way, the rebate amount on the aggregate of a group of payments made by the payer may be a fraction of the sum of the aggregate transaction fees applied to the each payment of the group of payments, or a fraction of the of the aggregate transaction fees applied to each payment of the group of payments above a minimum transaction fee threshold.

After the amount of the rebate is determined, the payment bureau 10 may generate a rebate instruction 198 to the payment system 30a to initiate: i) a debit transaction to debit the amount of the rebate from the operator account 34 as depicted by step 200 and ii) a credit transaction to credit the amount of the rebate to the payer's account as depicted by step 202.

Again, the debit(s) of the operator account and credit to the payer's account may be by funds transfer if between accounts held at the same bank or by transfer through a settlement network 32 if between accounts are held at different banks.

In an alternative embodiment, the rebate instruction 198 may be an instruction, or a debit/credit instruction pair, sent directly by the payment application 18 the settlement network 32 (whether separate from, or part of the payment bureau 10) to effect the initiation of a debit transaction to debit the rebate amount from the operator account and credit the rebate amount to the payer's account.

In one embodiment, the payment bureau 10 performs the rebate steps 175 once per payment, meaning the payment bureau 10 may calculate and disburse a rebate to the payer on each payment within the payment file.

In a second embodiment, the payment bureau 10 performs the rebate steps 175 once for all payments within the payment file, meaning the payment bureau 10 may calculate and disburse a rebate to the payer based at least in part on the aggregate of the payments, or the aggregate amount of the payments, within the payment file.

In a third embodiment, the rebate steps 175 may be performed only after multiple payment files are received from the payer over a set period of time, for example payment steps 175 may be performed only once every six (6) months for calculating a rebate based on the group of all payments made by the payer during a six (6) month period preceding the calculation and payment of the rebate.

In yet a fourth embodiment, rebate steps 175 may be performed only after multiple payment files are received from the payer which in the aggregate total a certain payment value. For example the aggregate value of all payments made by the payer achieves a threshold value which triggers performance of the payment steps 175 and payment of a rebate based on payments used for calculating the aggregate total.

Referring to the ladder diagram of FIG. 8b in conjunction with FIG. 1, in a second exemplary embodiment of operation, the payment bureau 10 receives a payment file, for example payment file 160b (FIG. 7b) from payer 14b, as represented by step 22. Again, the payment instruction file may be transferred via a secure connection over the network 20 which may include implementing encryption of the connection and/or the file transferred over the connection.

Upon receiving and authenticating the payment file 160, the payment bureau 10, or more specifically, the processor 40 executing the payment application 18, performs funding steps 173 to transfer a funding amount equal to the aggregate or sum of the amount of all payments in the payment file 160 from the payer's account (account 36b at bank 28a) to the settlement account 34.

The funding steps 173 may include generating a funding instruction 176 to the payment system 30a to which the payment bureau 10 is coupled. The funding instruction 176 may include initiation of a debit transaction to debit the funding amount from the payer's transaction account (account 36a) as represented by step 178 and a credit transaction to credit to the settlement account 34 the funding amount as represented by step 180. The funding steps 173 may further include the payment system 30a providing a message back to the payment bureau verifying that the funding amount has been received in the settlement account 34.

The debit of the payer's account and credit to the settlement account may be by funds transfer if both accounts are held at the same bank, by transfer through a settlement network 32 (for example via ACH or Wire) if the payers account and settlement account are held at different banks.

In a second funding embodiment, the funding instruction 176 may be an instruction, or a debit/credit instruction pair, sent directly by the payment application 18 to the settlement network 32 to effect the initiation of a debit transaction to debit the funding amount from payer's account (account 36a) as represented by step 178 and initiation of a credit transaction to credit to the settlement account 34 the funding amount as represented by step 180.

As discussed, the settlement network 32 may be separate from the payment bureau 10, such as the Fedwire settlement network or the ACH settlement network, or may be a proprietary component of the payment bureau 10, such as a bank card association settlement network. In an embodiment wherein the settlement network 32 is part of the payment bureau 10, the settlement network 32 may be an application comprising instructions stored on the computer readable medium 42 and executed by processor 40, such instructions implementing the credit and debit transactions as described in this specification.

In a third funding embodiment, the funding instruction 176 may be a message to the payer from which the payment file was received. The payer may then, accessing a payment system 30 at the payer's bank or a settlement network, initiate a debit transaction to debit the funding amount from payers account (account 36a) as represented by step 178 and initiation of a credit transaction to credit to the settlement account 34 the funding amount as represented by step 180. The message to the payer may simple be a message acknowledging receipt of the payment file.

In both the second funding embodiment and the third funding, the verification of receipt of the funding amount in the settlement account 34 may be a message to the payment bureau 10 that is generated by the bank at which the settlement account 34 is held.

After the funding amount is received in the settlement account 34, disbursement and rebate steps 177 are performed for each payment represented in the payment file.

At step 184, the payment bureau 10 identifies a payment transaction fee to charge the supplier for receipt of the payment in the manner discussed with respect to FIGS. 9a and 9b. At step 196 the payment bureau 10 determines rebate due to the payer in the manner discussed with respect to FIG. 8a.

Thereafter, the payment bureau 10 generates disbursement instructions 186, 188, and 204 to the payment system 30a to initiate: i) a debit transaction, or multiple debit transactions, to debit the payment amount from the settlement account 134 as depicted by step 190; ii) a credit transaction to credit the payment amount less the transaction fee to the supplier's transaction account as depicted by step 192; iii) a credit transaction to credit the transaction fee less the rebate to the operator account 37 as depicted by step 204; and iv) a credit transaction to credit the rebate to the payer account as depicted by step 208.

The debit(s) of the settlement account and credits to the supplier's transaction account, the operator account, and the payer account may be by funds transfer if between accounts held at the same bank or by transfer through a settlement network 32 if between accounts held at different banks.

In an alternative embodiment each of the disbursements instructions 186, 188 and 204 may each be an instruction, or a debit/credit instruction pair, sent directly by the payment application 18 to the settlement network 32 (whether separate from the payment bureau 10 or a component of the payment bureau 10) to effect debit transaction to debit the applicable amount from the settlement account and credit the amount of the payment less the transaction fee to the supplier account and to credit the transaction fee to the operator account.

It should be appreciated that the disbursement instructions to effect the credits and debits as discussed with respect to the disbursement and rebate steps 177, for each of multiple transactions, may be grouped in batches for transmission to the payment system 30a or the settlement network 32.

Again although the foregoing description of the funding steps 173 and disbursement and rebate steps 177 contemplate funding the settlement account for the aggregate amount of all payments within the payment file through a single funding transaction, as an alternative, the funding steps 173 may be independently performed for each payment within the payment file, in each case funding only the amount of the particular payment to the settlement account.

Referring to the ladder diagram of FIG. 8c in conjunction with FIG. 1, in a third exemplary embodiment of operation, the payment bureau 10 receives a payment file, for example payment file 160a (FIG. 7a) from payer 14a, as represented by step 22. Again, the payment instruction file may be transferred via a secure connection over the network 20 which may include implementing encryption of the connection and/or the file transferred over the connection.

Upon receiving and authenticating the payment file 160a, the payment bureau 10, or more specifically, the processor 40 executing the payment application 18, performs payment transaction fee and rebate calculation steps 179 for each payment within the payment file. Step 184 represents the payment bureau 10 identifying, for the payment, a payment transaction fee to charge the supplier for receipt of that payment in the manner discussed with respect to FIGS. 9a and 9b. Step 196 represents the payment bureau 10 determining the rebate due to the payer based on the payments in the file in the manner discussed with respect to FIG. 8a.

After performing the payment transaction fee and rebate calculation steps, the payment bureau 10 performs funding steps 173. In a first embodiment, funding steps 173 represent a transfer a funding amount equal to the aggregate or sum of the amount of all payments in the payment file 160, less the applicable rebate on all payments in the payment file 160, from the payer's account (account 36a at bank 28a) to the settlement account 34.

The funding steps 173 may include generating a funding instruction 176 to the payment system 30a to which the payment bureau 10 is coupled. The funding instruction 176 may include initiation of a debit transaction to debit the funding amount (sum of payments less rebate) from the payer's transaction account (account 36a) as represented by step 210 and a credit transaction to credit to the settlement account 34 the funding amount as represented by step 212. The funding steps 173 may further include the payment system 30a providing a message back to the payment bureau verifying that the funding amount has been received in the settlement account 34 as represented by step 182.

Again, the debit of the payer's account and credit to the settlement account may be by funds transfer if both accounts are held at the same bank, by transfer through a settlement network 32 (for example via ACH or Wire) if the payers account and settlement account are held at different banks.

Again, the funding instruction 176 may be an instruction, or a debit/credit instruction pair, sent directly by the payment application 18 to the settlement network 32 (whether separate from the payment bureau 10 or part of the payment bureau 10) to effect the initiation of a debit transaction to debit the funding amount from payer's account (account 36a) as represented by step 210 and initiation of a credit transaction to credit to the settlement account 34 the funding amount as represented by step 212.

Again, the funding instruction 176 may be a message to the payer from which the payment file was received. The payer may then, accessing a payment system 30 at the payer's bank or a settlement network, initiate a debit transaction to debit the funding amount from payers account (account 36a) as represented by step 210 and initiation of a credit transaction to credit to the settlement account 34 the funding amount as represented by step 212. The message to the payer may simple be a message acknowledging receipt of the payment file.

In both the second funding embodiment and the third funding, the verification of receipt of the funding amount in the settlement account 34 may be a message to the payment bureau 10 that is generated by the bank at which the settlement account 34 is held.

After the funding amount is received in the settlement account 34, disbursement steps 181 are performed for each payment represented in the payment file. The payment bureau 10 generates disbursement instructions 186 and 188 to the payment system 30a to initiate: i) a debit transaction, or multiple debit transactions, to debit the payment amount less the rebate from the settlement account 134 as depicted by step 214; ii) a credit transaction to credit the payment amount less the transaction fee to the supplier's transaction account as depicted by step 216; and iii) a credit transaction to credit the transaction fee less the rebate to the operator account 37 as depicted by step 218.

Again, the debit(s) of the settlement account and credits to the supplier's transaction account, the operator account, and the payer account may be by funds transfer if between accounts held at the same bank or by transfer through a settlement network 32 if between accounts held at different banks.

Again, disbursements instructions 186 and 188 may each be an instruction, or a debit/credit instruction pair, sent directly by the payment bureau 10 to the settlement network 32 (whether separate from payment bureau 10 or a component of payment bureau 10) to effect the initiation of a debit transaction to debit the applicable amount from the settlement account and credit the amount of the payment less the transaction fee to the supplier account and to credit the transaction fee to the operator account.

As discussed, the payment bureau will complete the disbursement steps 181 for each payment within the payment file 160a, with an alternative variant being that the credit of the payment transaction fee, less the rebate, to the operator account 37 as represented by step 218 may be a single transaction that credits to the operator account the aggregate of the transaction fees for multiple payments, less the aggregate rebated for those multiple payments. Such a single transaction may be performed with respect to all payments in the payment file, or all payments processed over a period of time, for example a day, whether the aggregate represents payments for a single payer or multiple payers.

Again, it should be appreciated that the disbursement instructions to effect the credits and debits as discussed with respect to the disbursement and rebate steps 181, for each of multiple transactions, may be grouped in batches for transmission to the payment system 30a or the settlement network 32.

Again although the foregoing description of the funding instructions 173 and disbursement and rebate instructions 177 contemplate funding the settlement account for the aggregate amount of all payments within the payment file through a single funding transaction, as an alternative, the funding instructions 173 may be independently performed for each payment within the payment file, in each case funding only the amount of the particular payment to the settlement account.

Referring to the ladder diagram of FIG. 8d in conjunction with FIG. 1, in yet another exemplary embodiment of operation, the payment bureau 10 receives a payment file, for example payment file 160b (FIG. 7b) from payer 14b, as represented by step 22. The payment instruction file may be transferred via a secure connection over the network 20 which may include implementing encryption of the connection and/or the file transferred over the connection.

Upon receiving and authenticating the payment file 160, the payment bureau 10, or more specifically, the processor 40 executing the payment application 18, performs payment steps 171 for each payment represented in the payment file 160. Step 184 represents determining the payment transaction fee to apply to the payment as discussed with respect to FIGS. 9a and 9b.

The payment bureau then generates payment instruction 220 to the payment system 30a to initiate: i) a debit transaction to debit the payment amount from the payer's account as depicted by step 226; ii) a credit transaction to credit the payment amount less the transaction fee to the supplier's transaction account as depicted by step 224; and iii) a credit transaction to credit the transaction fee to the operator account 37 as depicted by step 226.

Again, the debit(s) of the payers transaction account and credits to the supplier's transaction account and operator account by funds transfer if between accounts held at the same bank or by transfer through a settlement network 32 if between accounts held at different banks.

Again, the payment instruction 220 may be an instruction, or a debit/credit instruction combination, sent directly by the payment application 18 to the settlement network 32 (whether distinct from the payment bureau 10 or part of the payment bureau 10) to effect the initiation of a debit transaction to debit the applicable amount from the payers transaction account and credit the amount of the payment less the transaction fee to the supplier transaction account and to credit the transaction fee to the operator account.

After disbursement steps 171 are executed for each payment within the payment file 160, rebate steps 175 may be executed for calculating and paying a rebate to the payer. More specifically, step 196 represents calculating a rebate due to the payer in the manner discussed with respect to FIG. 8a. After the amount of the rebate is determined, the payment bureau 10 may generate a rebate instruction 198 to the payment system 30a to initiate: i) a debit transaction to debit the amount of the rebate from the operator account 34 as depicted by step 200 and ii) a credit transaction to credit the amount of the rebate to the payer's account as depicted by step 202.

In one embodiment, the payment bureau 10 performs the rebate instructions 175 once per payment, meaning the payment bureau 10 may calculate and disburse a rebate to the payer on each payment within the payment file.

In a second embodiment, the payment bureau 10 performs the rebate instructions once for all payments within the payment file, meaning the payment bureau 10 may calculate and disburse a rebate to the payer based at least in part on the aggregate of the payments, or the aggregate amount of the payments, within the payment file.

In a third embodiment, the rebate instructions 175 may be performed only after multiple payment files are received from the payer over a set period of time, for example payment instructions 175 may be performed only once every six (6) months for calculating a rebate based on all payments made by the payer during a six (6) month period preceding the calculation and payment of the rebate.

In yet a fourth embodiment, rebate steps 175 may be performed only after multiple payment files are received from the payer which in the aggregate total a certain payment value. For example the aggregate value of all payments made by the payer achieves a threshold value which triggers performance of the payment steps 175 and payment of a rebate based on payments used for calculating the aggregate total.

Referring to the ladder diagram of FIG. 8e in conjunction with FIG. 1, in yet another exemplary embodiment of operation, the payment bureau 10 receives a payment file, for example payment file 160a (FIG. 7a) from payer 14a, as represented by step 22. Again, the payment instruction file may be transferred via a secure connection over the network 20 which may include implementing encryption of the connection and/or the file transferred over the connection.

Upon receiving and authenticating the payment file 160, the payment bureau 10, or more specifically, the processor 40 executing the payment application 18, payment transaction fee and rebate calculation steps 179. In one embodiment, at step 184, the payment bureau 10 identifies, for each payment in the payment file, a payment transaction fee to charge the supplier for receipt of that payment in the manner discussed with respect to FIGS. 9a and 9b. At step 196 the payment bureau 10 determines rebate due to the payer based on the payments in the file in the manner discussed with respect to FIG. 8a.

After performing the payment transaction fee and rebate calculation steps 179, the payment bureau 10 performs payment steps 183 to for each payment represented in the payment file. The payment bureau 10 generates payment instruction 228 to the payment system 30a to initiate: i) a debit transaction, or multiple debit transactions, to debit the payment amount less the rebate from the payer account as depicted by step 230; ii) a credit transaction to credit the payment amount less the transaction fee to the supplier's transaction account as depicted by step 232; and iii) a credit transaction to credit the transaction fee less the rebate to the operator account 37 as depicted by step 234.

Again, the debit of the payer's account and credit to the supplier's account and operator account may be by funds transfer if both accounts are held at the same bank, by transfer through a settlement network 32 (for example via ACH or Wire) if the payers account and settlement account hare held at different banks.

Again, the payment instruction 228 may be an instruction or a debit/credit combination of instructions, sent directly by the payment application 18 to a settlement network 32 (whether distinct from the payment bureau 10 or part of the payment bureau 10) to effect the initiation of a debit transaction to debit the payment amount less the rebate from payers account (account 36a) as represented by step 230 and initiation of a credit transaction to credit to the suppliers account the payment amount less the transaction fee as represented by step 232 and initiation of a credit transaction to credit the operator account the transaction fee less the rebate as represented by step 234.

In a third embodiment, the payment instruction 228 may be a message to the payer from which the payment file was received. The payer may then, accessing a payment system 30 at the payer's bank or a settlement network, initiates a debit transaction to debit the payment amount less the rebate from payers account (account 36a) as represented by step 230 and initiation of a credit transaction to credit to the supplier's account the payment amount less the transaction fee as represented by step 232, and initiation of a credit transaction to credit to the operator account the amount of the transaction fee less the rebate as represented by step 234.

In summary, the present invention provides a system for making payments from a payer to a community of suppliers, assessing a variable transaction fee to each supplier, and providing a variable rebate to the payer. Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. A system for making payments from a payer to a community of suppliers, assessing a variable transaction fee to each supplier, and providing a variable rebate to the payer, the system comprising:
a database, the database comprising:
identification of a first payer; and, in association with the identification of the first payer:
identification of a first payer supplier group, the first payer supplier group being a first subset of the community of suppliers that consists of fewer than the entire community of suppliers;
to identification of each supplier in a first sub group of the first payer supplier group to which a first transaction rate applies; and
identification of each supplier in a second sub group of the first payer supplier group to which a second transaction rate applies, each supplier in the second sub group being distinct from each supplier in the first subgroup;
a first payment instruction, the first payment instruction including identification of the first payer, a first supplier ID number, and identification of an amount of a first payment;
a second payment instruction including identification of the first payer, a second supplier ID number, and identification of an amount of a second payment;
a payment application comprising instructions stored in a memory and executed by a processor, the instructions comprising:
identify a first transaction fee to assess the first supplier by:
looking up, in the supplier transaction fee database, whether the first supplier is a member of the first subgroup or the second subgroup of the first payer supplier group;
looking up, in the supplier transaction fee database, a transaction rate, the transaction rate being:
the first transaction rate if the first supplier is a member of the first subgroup of the first payer supplier group; and
the second transaction rate if the first supplier is a member of the second subgroup of the first payer supplier group; and
multiplying the amount of the first payment by the transaction rate;
identify a second transaction fee to assess the second supplier by:
looking up, in the supplier transaction fee database, whether the second supplier is a member of the first subgroup or the second subgroup of the first payer supplier group;
looking up, in the supplier transaction fee database, a transaction rate, the transaction rate being:
the first transaction rate if the second supplier is a member of the first subgroup of the first payer supplier group; and
the second transaction rate if the second supplier is a member of the second subgroup of the first payer supplier group; and
multiplying the amount of the second payment by the second transaction rate;
crediting, to the account of the first supplier, an amount equal to the first payment less the first transaction fee; and
crediting, to the account of the second supplier, an amount equal to the first payment less the second transaction fee; and
crediting, to the account of the first payer, a first rebate amount equal to so the a fraction of the first transaction fee, the fraction being less than one.

2. The system of claim 1, wherein the payment application further comprises instructions for crediting the amount of the first transaction fee and the second transaction fee to an account associated with an operator of the system.

3. The system of claim 2, wherein the payment application further comprises instructions for crediting a first rebate amount to an account associated with the first payer, the first rebate amount being a fraction of the sum of the first transaction fee and the second transaction fee, the fraction being less than one.

4. The system of claim 1, wherein the payment application further comprises instructions for crediting to the account of an operator of the system, an amount equal to the sum of: i) the first transaction fee less the first rebate amount; and ii) the second transaction fee less the second rebate amount.

5. The system of claim 1, wherein identifying the first transaction fee further includes, after determining the first transaction fee by multiplying the amount of the first payment by the transaction rate,
If the first transaction fee is below a minimum threshold value, adjusting the first transaction fee to a predetermined minimum transaction fee; and
If the first transaction fee is above a maximum threshold value, adjusting the first transaction fee to a predetermined maximum threshold value.

6. A system for making payments from a plurality of payers to a community of suppliers, assessing a variable transaction fee to each supplier, and providing a variable rebate to the payer, the system comprising:
a database, the database comprising:
identification of a first payer; and, in association with the identification of the first payer:
identification of a first payer supplier group, the first payer supplier group being a first subset of the community of suppliers that consists of fewer than the entire community of suppliers;
identification of each supplier in a first sub group of the first payer supplier group to which a first transaction rate applies; and
identification of each supplier in a second sub group of the first payer supplier group to which a second transaction rate applies, each supplier in the second sub group being distinct from each supplier in the first subgroup, the first transaction rate being distinct from the second transaction rate;
identification of which of the first subgroup of the first payer supplier sub group and the second subgroup of the first payer supplier subgroup to which the a first supplier is assigned;
identification of a second payer; and, in association with the identification of the second payer:
identification of a second payer supplier group, the second payer supplier group being a second subset of the community of suppliers that consists of fewer than the entire community of suppliers;
identification of each supplier in a first sub group of the second payer supplier group to which a third transaction rate applies; and
identification of each supplier in a second sub group of the second payer supplier group to which a third transaction rate applies, each supplier in the second sub group being distinct from each supplier in the first subgroup, each of the first, second, third and fourth transaction rates being distinct;
identification of which of the first subgroup of the first payer supplier sub group and the second subgroup of the first payer supplier subgroup to which the a first supplier is assigned;
a first payment instruction, the first payment instruction including identification of:
a first payment amount;
the first payer, and
the subgroup of the first payer supplier subgroup to which the supplier is assigned;
a second payment instruction, the second payment instruction including identification of:
a second payment amount;
the second payer; and
the subgroup of the second payer supplier subgroup to which the supplier is assigned;
a payment application comprising instructions stored in a memory and executed by a processor, the instructions comprising:
determine a first transaction fee to assess the supplier on the first payment amount by:
looking up, in the database, the transaction rate associated with the subgroup of the first payer supplier subgroup to which the supplier is assigned;
so multiplying the first payment amount by the transaction rate associated with the subgroup of the first payer supplier subgroup to which the supplier is assigned;
determine a second transaction fee to assess the supplier on the second payment amount by:
looking up, in the database, the transaction rate associated with the subgroup of the second payer supplier subgroup to which the supplier is assigned;
multiplying the second payment amount by the transaction rate associated with the subgroup of the second payer supplier subgroup to which the supplier is assigned;
crediting, to the account of the supplier, an amount equal to the first payment less the first transaction fee; and
crediting, to the account of the supplier, an amount equal to the second payment less the second transaction fee; and
crediting, to the account of the first payer, a first rebate amount equal to the a fraction of the first transaction fee, the fraction being less than one; and
crediting, to the account of the second payer, a second rebate amount equal to a fraction of the second transaction fee, the fraction being less than one.

7. The system of claim 6, wherein the payment application further comprises instructions for crediting the amount of the first transaction fee and the second transaction fee to an account associated with an operator of the system.

8. The system of claim 7, wherein the payment application further comprises instructions for:
crediting a first rebate amount to an account associated with the first payer, the first rebate amount being a fraction of the first transaction fee, the fraction being less than one.
crediting a second rebate amount to an account associated with the second payer, the second rebate amount being a fraction of the second transaction fee, the fraction being less than one.

9. The system of claim 6, wherein the payment application further comprises instructions for:
crediting a first rebate amount to an account associated with the first payer, the first rebate amount being a fraction of the first transaction fee, the fraction being less than one.
crediting a second rebate amount to an account associated with the second payer, the second rebate amount being a fraction of the second transaction fee, the fraction being less than one; and
crediting the amount of: i) the first transaction fee less the first rebate; and ii) the second transaction fee less the second rebate to an account associated with an operator of the system;

10. The system of claim 6, wherein identifying the first transaction fee further includes, after determining the first transaction fee by multiplying the amount of the first payment by the transaction rate,
If the first transaction fee is below a minimum threshold value, adjusting the first transaction fee to a predetermined minimum transaction fee; and
If the first transaction fee is above a maximum threshold value, adjusting the first transaction fee to a predetermined maximum threshold value.

11. A system for making payments from a payer to a community of suppliers and assessing a variable transaction fee to each supplier, the system comprising:
a database, the database comprising:
identification of a first payer; and, in association with the identification of the first payer:
identification of a first transaction rate;
identification of a first subset of the community of suppliers to which the first transaction rate applies to payments made by the first payer;
identification of a second transaction rate;
to identification of a second subset of the community of suppliers to which the second transaction rate applies to payments made by the first payer;
identification of a second payer; and, in association with the identification of the second payer:
identification of a third transaction rate;
identification of a third subset of the community of suppliers to which the third transaction rate applies to payments made by the second payer;
identification of a fourth transaction rate;
identification of a fourth subset of the community of suppliers to which the fourth transaction rate applies to payments made by the second payer;
a first payment instruction, the first payment instruction including identification of the first payer, a first supplier ID number, and identification of an amount of a first payment;
a second payment instruction including identification of the first payer, a second supplier ID number, and identification of an amount of a second payment;
a payment application comprising instructions stored in a memory and executed by a processor, the instructions comprising:
determining a transaction fee to apply to the first payment by:
multiplying the amount of the first payment by the first transaction rate if the supplier is a member of the first subgroup of the community of suppliers;
multiplying the amount of the second payment by the second transaction rate if the supplier is a member of the second subgroup of the community of suppliers;
generating a first credit transaction to credit, to the account of the supplier, an amount equal to the first payment less the transaction fee applied to the first payment;
determining a transaction fee to apply to the second payment by:
multiplying the amount of the second payment by the third transaction rate if the supplier is a member of the third subgroup of the community of suppliers;
multiplying the amount of the second payment by the fourth transaction rate if the supplier is a member of the fourth subgroup of the community of suppliers;
generating a second credit transaction to credit, to the account of the supplier, an amount equal to the second payment less the transaction fee applied to the second payment;

12. The system of claim 11, wherein the payment application further comprises instructions for crediting the amount of the first transaction fee and the second transaction fee to an account associated with an operator of the system.

13. The system of claim 12, wherein the payment application further comprises instructions for crediting a first rebate amount to an account associated with the first payer, the first rebate amount being a fraction of the sum of the first transaction fee and the second transaction fee, the fraction being less than one.

14. The system of claim 11, wherein the payment application further comprises instructions for crediting to the account of an operator of the system, an amount equal to the sum of: i) the first transaction fee less the first rebate amount; and ii) the second transaction fee less the second rebate amount.

15. The system of claim 11, wherein identifying the first transaction fee further includes, after determining the first transaction fee by multiplying the amount of the first payment by the transaction rate,
If the first transaction fee is below a minimum threshold value, adjusting the first transaction fee to a predetermined minimum transaction fee; and
If the first transaction fee is above a maximum threshold value, adjusting the first transaction fee to a predetermined maximum threshold value.

16. A system for making payments from each payer of a community of payers to each supplier of a community of suppliers and assessing a variable transaction fee to each supplier, the system comprising:
a database, the database comprising:
a data structure:
associating a first payer of the community of payers with identification of a group of transaction rates to apply to payments made by the first payer, each transaction rate of the group of transaction rates being a rate distinct from the other transaction rates of the group of transaction rates;
to associating each transaction rate of the group of transaction rates ii with identification of a subgroup of suppliers to which the transaction rate applies on payments made by the first payer, each subgroup of suppliers being group of suppliers that is mutually exclusive of the group of suppliers in each other subgroup of suppliers;
associating a second payer of the community of payers with is identification of a group of transaction rates to apply to payments made by the first payer, each transaction rate of the group of transaction rates being a rate distinct from the other transaction rates of the group of transaction rates;
associating each transaction rate of the group of transaction rates with identification of a subgroup of suppliers to which the transaction rate applies on payments made by the second payer, each subgroup of suppliers being group of suppliers that is mutually exclusive of the group of suppliers in each other subgroup of suppliers;
a first payment instruction, the first payment instruction identifying a payer, first supplier and a first payment amount;
a payment application comprising instructions stored in a memory and executed by a processor, the instructions comprising:
generating a first credit transaction to the account of the first supplier, the credit transaction being in the amount of the first payment less a first transaction fee, the first transaction fee being the amount of the first payment multiplied by the transaction rate, of the group of transaction rates associated with the payer, that associates with the subgroup of suppliers to which the first supplier is associated.

17. The system of claim 16, wherein the payment application further comprises instructions for crediting the amount of the first transaction fee and the second transaction fee to an account associated with an operator of the system.

18. The system of claim 17, wherein the payment application further comprises instructions for:
crediting a first rebate amount to an account associated with the first payer, the first rebate amount being a fraction of the first transaction fee, the fraction being less than one.
crediting a second rebate amount to an account associated with the second payer, the second rebate amount being a fraction of the second transaction fee, the fraction being less than one.

19. The system of claim 16, wherein the payment application further comprises instructions for:
crediting a first rebate amount to an account associated with the first payer, the first rebate amount being a fraction of the first transaction fee, the fraction being less than one.
crediting a second rebate amount to an account associated with the second payer, the second rebate amount being a fraction of the second transaction fee, the fraction being less than one; and
crediting the amount of: i) the first transaction fee less the first rebate; and ii) the to second transaction fee less the second rebate to an account associated with an operator of the system;

20. The system of claim 16, wherein identifying the first transaction fee further includes, after determining the first transaction fee by multiplying the amount of the first payment by the transaction rate,
If the first transaction fee is below a minimum threshold value, adjusting the first transaction fee to a predetermined minimum transaction fee; and
If the first transaction fee is above a maximum threshold value, adjusting the first transaction fee to a predetermined maximum threshold value.
